(19) United States
(12) Patent Application Publication
(10) Pub. No.: US 2010/0151699 A1
(43) Pub. Date: Jun. 17, 2010

(54) ELECTRIC CONNECTOR APPARATUS

(76) Inventor: Ok-Nam Cho, Seoul (KR)

Correspondence Address: Olson & Cepuritis, LTD., 20 NORTH WACKER DRIVE, 36TH FLOOR, CHICAGO, IL, 60606, US

(21) Appl. No.: 12/733,071

(22) PCT Filed: Aug. 8, 2008
(86) PCT No.: PCT/KR2008/004617

§ 371 Date: Feb. 8, 2010

(30) Foreign Application Priority Data
Aug. 8, 2007 (KR) 10-2007-0079683

(51) Int. Cl. H01R 35/00

(52) U.S. Cl. 439/13

(57) ABSTRACT

An electric connector apparatus is disclosed. The electric connector apparatus, may include: a housing, which may be secured to an electronic product; a first inner terminal and a second inner terminal, which may be secured to the housing, and which may be electrically connected to an internal device of the electronic product; a rotation member, which may be coupled to the housing such that the rotation member is 3-dimensionally rotatable; and a first outer terminal and a second outer terminal, which may be secured to the rotation member and electrically connected to an external power source, while maintaining contact with the first inner terminal and the second inner terminal, respectively. The electric connector apparatus can rotate 3-dimensionally in accordance with the movement of the cable while maintaining electrical connection.

### TECHNICAL FIELD

The present invention relates to an electric connector apparatus used in electronic products, etc.

### BACKGROUND ART

An electronic product, such as a television set, refrigerator, hair dryer, and curling iron, etc., generally includes a cable that has a plug formed at the end, so as to be supplied with electricity from an external power source. Such a cable may be electrically connected with an internal component of the electronic device.

However, in a conventional electronic product, the cable was affixed to the internal component of the electronic product and would not allow rotatory movement. Because of this, if the cable was twisted, high levels of stress were applied on the connecting portion between the cable and the internal component, causing defective electrical links and disconnections. Such problems were especially frequent in smaller electronic products, such as hair dryers, curling irons, and electric razors, etc.

### DISCLOSURE

### Technical Problem

An aspect of the present invention is to provide an electric connector apparatus that can rotate 3-dimensionally in accordance with the movement of the cable while maintaining electrical connection.

Another aspect of the present invention is to provide an electric connector apparatus that can prevent defective links or disconnections and increase durability.

### Technical Solution

According to an aspect of the present invention, an electric connector apparatus is provided that includes: a housing, which may be secured to an electronic product; a first inner terminal and a second inner terminal, which may be secured to the housing, and which may be electrically connected to an internal device of the electronic product; a rotation member, which may be coupled to the housing such that the rotation member is 3-dimensionally rotatable; and a first outer terminal and a second outer terminal, which may be secured to the rotation member and electrically connected to an external power source, while maintaining contact with the first inner terminal and the second inner terminal, respectively.

The first outer terminal and the second outer terminal can be partially exposed at a surface of the rotation member and can be spaced apart from each other such that the first outer terminal and the second outer terminal are electrically separated.

A portion of the second outer terminal exposed at the surface of the rotation member can be shaped as a ring that surrounds the surface of the rotation member.

At least one pair of the first inner terminal and the first outer terminal and of the second inner terminal and the second outer terminal can contact each other elastically.

The first outer terminal can include: a first outer connecting portion, which may be secured to the rotation member and electrically connected with the external power source; a first rotational contact portion, which may be coupled to the first outer connecting portion in such a way that the first rotational contact portion is movable towards the first inner terminal; and a spring, which may be interposed between the first outer connecting portion and the first rotational contact portion such that the first inner terminal and the first rotational contact portion maintain contact with each other.

The second inner terminal can elastically support the rotation member.

The first outer terminal and the second outer terminal can have convex shapes, while at least one of the first inner terminal and the second inner terminal can have a concave shape corresponding with the shapes of the first outer terminal and the second outer terminal.

The second outer terminal can include: a second rotational contact portion, which may be positioned in contact with the second inner terminal; and a second outer connecting portion, which may be electrically connected with the external power source, and which may be formed independently of the second rotational contact portion to be coupled to the second rotational contact portion.

The second outer connecting portion can be elastically deformed to be coupled to the second rotational contact portion.

The rotation member can be shaped as at least a portion of a sphere, and a receiving indentation can be formed inside the housing in correspondence with the rotation member such that the receiving indentation holds the rotation member.

An opening of the receiving indentation that exposes the first outer terminal and the second outer terminal can have a smaller width than the maximum diameter of the rotation member.

The opening can be circular.

A cap may further be included, which may be secured to an end of the rotation member to prevent foreign substances from entering the housing.

### DESCRIPTION OF DRAWINGS

FIG. 1 is an assembled perspective view of an electric connector apparatus according to an embodiment of the present invention.

FIG. 2 is an exploded perspective view of an electric connector apparatus according to an embodiment of the present invention.

FIG. 3 is a partially assembled perspective view of an electric connector apparatus according to an embodiment of the present invention.

FIG. 4 and FIG. 5 are a perspective view and a front elevational view of an upper housing according to an embodiment of the present invention.

FIG. 6 and FIG. 7 are a front elevational view and a rear elevational view of a lower housing according to an embodiment of the present invention.

FIG. 8 is a perspective view of a rotation member according to an embodiment of the present invention.

FIG. 9 is a perspective view of another type of rotation member according to an embodiment of the present invention.

FIG. 10 is a front elevational view of a first outer terminal according to an embodiment of the present invention.

FIG. 11 is a perspective view of another type of first outer terminal according to an embodiment of the present invention.

FIG. 12 is a side elevational view of a second outer terminal according to an embodiment of the present invention.

FIG. 13 is a perspective view of another type of second outer terminal according to an embodiment of the present invention.

FIG. 14 is a side elevational view of a first inner terminal according to an embodiment of the present invention.

FIG. 15 is a front elevational view of a second inner terminal according to an embodiment of the present invention.

### DESCRIPTION OF NUMERALS

100: electric connector apparatus

120: housing

122: upper housing

142: lower housing

160: first outer terminal

170: second outer terminal

180: first inner terminal

190: second inner terminal

210: rotation member

230: cap

### MODE FOR INVENTION

As the invention allows for various changes and numerous embodiments, particular embodiments will be illustrated in the drawings and described in detail in the written description. However, this is not intended to limit the present invention to particular modes of practice, and it is to be appreciated that all changes, equivalents, and substitutes that do not depart from the spirit and technical scope of the present invention are encompassed in the present invention. In the description of the present invention, certain detailed explanations of related art are omitted when it is deemed that they may unnecessarily obscure the essence of the invention.

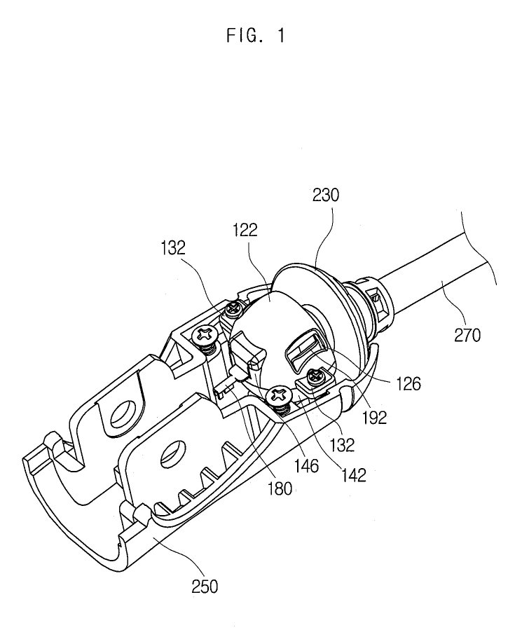

FIG. 1 illustrates an electric connector apparatus 100 according to an embodiment of the present invention secured to the casing 250 of an electronic equipment.

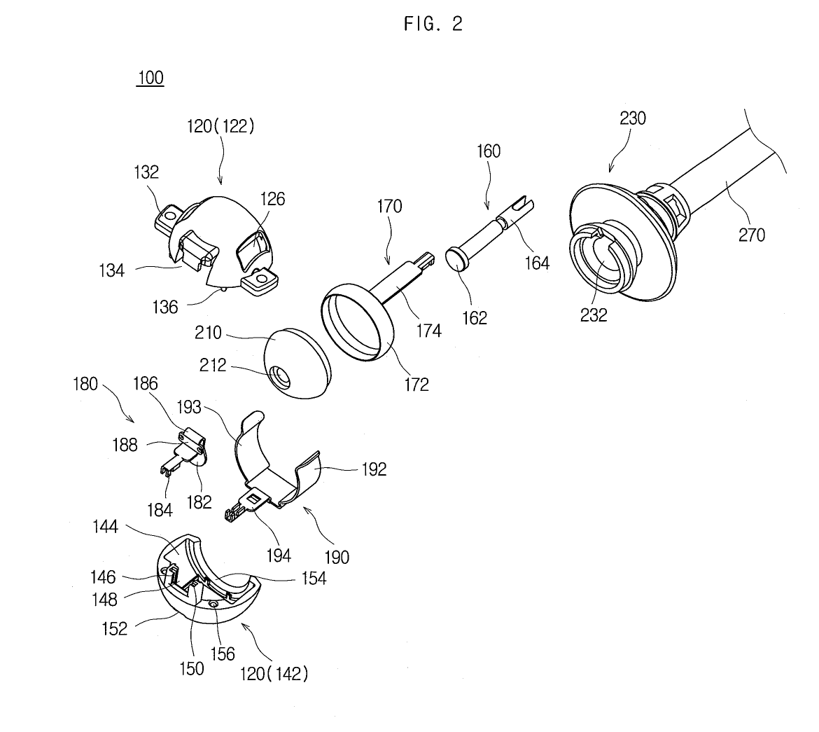

Referring to FIG. 1, an electric connector apparatus 100 according to an embodiment of the invention may include a housing, which may be composed of an upper housing 122 and a lower housing 142. Securing flaps 132 may be formed on the sides of the housing, where the securing flaps 132 may be secured to the casing 250 by way of screws, etc. A first inner terminal 180 and a second inner terminal 190 (see FIG. 2) protruding outwards from the lower housing 142 may be connected to an internal device in the electronic product. Also, a cap 230 which prevents foreign substances from entering the housing 120 (see FIG. 2) may be coupled to an end portion of the rotation member, and a cable 270 may be inserted in the cap 230 to electrically connect the first inner terminal 180 and the second inner terminal 190.

By way of an electric connector apparatus 100 according to the present embodiment, the cable 270 can undergo a 3-dimensional rotatory movement, instead of being secured inside the electric connector apparatus 100. Because of this, even when the cable is rotated or moved, there may be no stresses applied to the connecting portion between the cable and the internal device of the electronic product, so that the safety and durability of the electronic product can be improved.

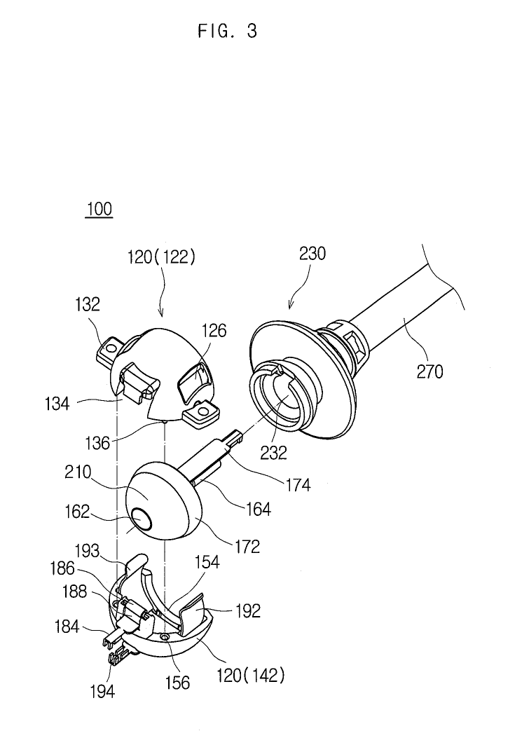

FIG. 2 is an exploded perspective view illustrating an electric connector apparatus 100 according to an embodiment of the present invention in an unassembled state, while FIG. 3 is a perspective view with the first inner terminal 180 and the second inner terminal 190 secured to the housing 120 and the first outer terminal 160 and the second outer terminal 170 coupled to the rotation member 210.

Referring to FIG. 2 and FIG. 3, an electric connector apparatus 100 according to an embodiment of the present invention may include a housing 120 that may be composed of an upper housing 122 and a lower housing 142, a semi-spherical rotation member 210 that may be inserted in the housing 120 in a manner that allows 3-dimensional rotation, a first outer terminal 160 and a second outer terminal 170 that may rotate 3-dimensionally together with the rotation member 210, and a first inner terminal 180 and a second inner terminal 190 that may be secured inside the housing 120 and positioned in electrical contact with the first outer terminal 160 and the second outer terminal 170. Also, the electric connector apparatus 100 according to the present embodiment may include a cap 230 coupled to an end portion of the rotation member 210.

In this case, portions of the first outer terminal 160 and the second outer terminal 170, i.e. a first rotational contact portion 162 and a second rotational contact portion 172, may be exposed at the surface of the rotation member 210, and the first outer terminal 160 and the second outer terminal 170 may be spaced apart from each other so that they may be electrically separated. Therefore, when electricity is transferred between the first outer terminal 160 and the first inner terminal 180, and between the second outer terminal 170 and the second inner terminal 190, there may be no short-circuiting.

A cable 270 that supplies electricity from an external power source may be connected through the cap 230 to each of the first outer terminal 160 and the second outer terminal 170. The first outer terminal 160 and the second outer terminal 170 can both couple with the rotation member 210 to rotate 3-dimensionally. Thus, when the external cable 270 is moved, the first outer terminal 160 and second outer terminal 170 can follow the movement of the cable 270. Also, the first inner terminal 180 and the second inner terminal 190 can always maintain contact with the first outer terminal 160 and the second outer terminal 170, respectively, in spite of the 3-dimensional rotation of the first outer terminal 160 and second outer terminal 170. That is, the first rotational contact portion 162 of the first outer terminal 160 may have a certain diameter and the second rotational contact portion 172 of the second outer terminal 170 may have a certain width that always allow contact with the first fixed contact portion 182 of the first inner terminal 180 and the second fixed contact portion 192 of the second inner terminal 190, even when the first outer terminal 160 and the second outer terminal 170 are rotated 3-dimensionally due to the rotation of the external cable 270.

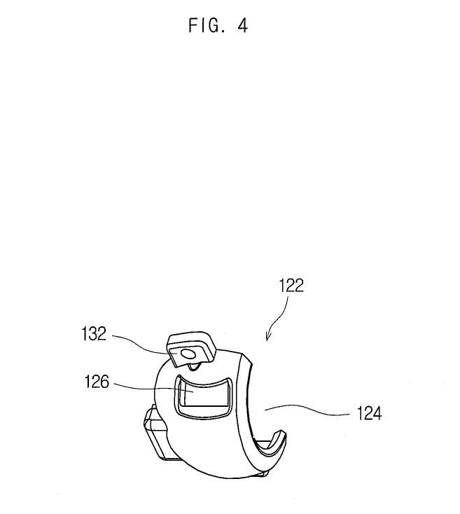

A description will be provided as follows, with reference to FIG. 4 through FIG. 15, on each component of an electric connector apparatus 100 according to an embodiment of the present invention.

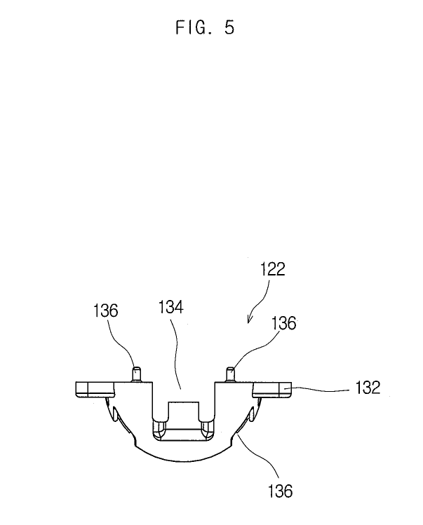

FIG. 4 and FIG. 5 illustrate an upper housing 122 in an electric connector apparatus according to an embodiment of the present invention.

Referring to FIG. 2, FIG. 4, and FIG. 5, an upper housing 122 according to the present embodiment may have a generally semi-spherical shape and may have an upper receiving indentation 124 formed in the center for holding the rotation member 210. The upper receiving indentation 124 may hold one half of the spherically shaped rotation member 210, and together with the lower receiving indentation 144 of the lower housing 142, may guide the 3-dimensional rotation of the rotation member 210. Securing flaps 132 may protrude outwards from the left and right sides of the upper housing 122. Holes may be formed in the securing flaps 132, and as illustrated in FIG. 1, screws may be inserted through the holes to secure the housing 120 to the casing 250.

Incised portions 126 may be formed on the circumference of the upper housing 122. Through the incised portions 126, the ends of the second fixed contact portion 192 of the second inner terminal 190 may be exposed to the exterior, as illustrated in FIG. 1. In the front surface of the upper housing 122, fitting indentations 134 may be formed. A protruding portion 146 on the lower housing 142 may be inserted into the fitting indentations 134. Also, coupling protrusions 136 may be formed on the upper housing 122. The coupling protrusions 136 may be inserted into coupling holes 156 in the lower housing 142, to firmly couple the upper housing 122 and the lower housing 142 together.

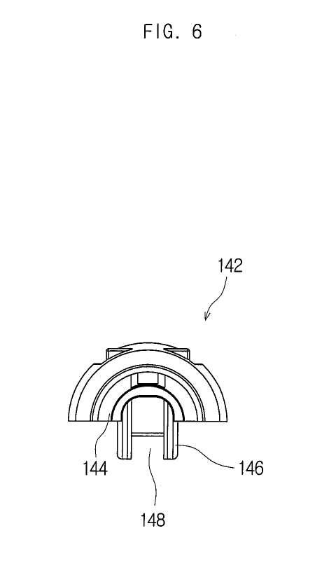

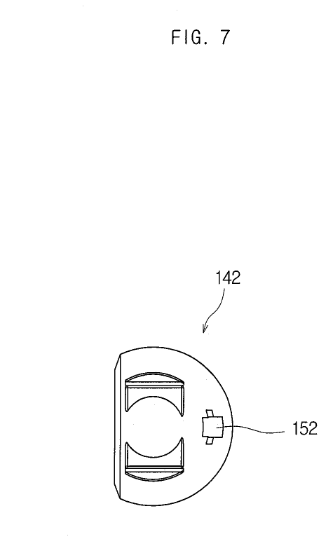

FIG. 6 and FIG. 7 illustrate a lower housing 142 in an electric connector apparatus according to an embodiment of the present invention.

Referring to FIG. 2, FIG. 6, and FIG. 7, the lower housing 142 may be formed in a generally semi-spherical shape and may include a lower receiving indentation 144 inside that can hold a portion of the rotation member 210. The lower receiving indentation 144 may form a receiving indentation 124, 144 with the upper receiving indentation 124, and this receiving indentation 124, 144 can guide the 3-dimensional rotatory movement of the rotation member 210.

Here, the opening of the receiving indentation 124, 144 that exposes the first outer terminal 160 and the second outer terminal 170 to allow connection to an external power source can have a width smaller than the diameter of the semi-spherical rotation member 210, so that the rotation member 210 held in the receiving indentation 124, 144 can be prevented from becoming separated from the housing 120 during 3-dimensional rotation.

Here, the opening may be circular, so that the cable coupled to the rotation member 210 may not be caught on the opening. Thus, the rotation member 210 can rotate freely, without any hindrance to its 3-dimensional rotation.

A protruding portion 146 may protrude upwards from a front surface of the lower housing 142, where a first insertion hole 148 and a raised portion 150 may be formed in the protruding portion 146, as illustrated in FIG. 2. An insertion portion 188 of the first inner terminal 180 can be inserted and secured onto the raised portion 150, and a first inner connecting portion 184 of the first inner terminal 180 may protrude through the first insertion hole 148 to the outside of the lower housing 142.

As illustrated in FIG. 7, a second insertion hole 152 may be formed in a front surface of the lower housing 142. A second inner connecting portion 194 of the second inner terminal 190 may be inserted in the second insertion hole 152 to protrude to the outside of the lower housing 142. The first insertion hole 148 and the second insertion hole 152 may be formed with a certain distance in-between, so that the first inner terminal 180, which may protrude to the outside through the first insertion hole 148, and the second inner terminal 190, which may protrude to the outside through the second insertion hole 152, may be electrically separated from each other.

As described above, the housing 120, which may be composed of an upper housing 122 and a lower housing 142, may function as a guide that supports the semi-spherically shaped rotation member 210 in a manner that allows smooth, 3-dimensional rotation. At the same time, it may also serve to secure the first inner terminal 180 and the second inner terminal 190. The upper housing 122 and lower housing 142 may be formed from an insulating material, to provide electrical insulation between the first outer terminal 160 and second outer terminal 170 and between the first inner terminal 180 and second inner terminal 190.

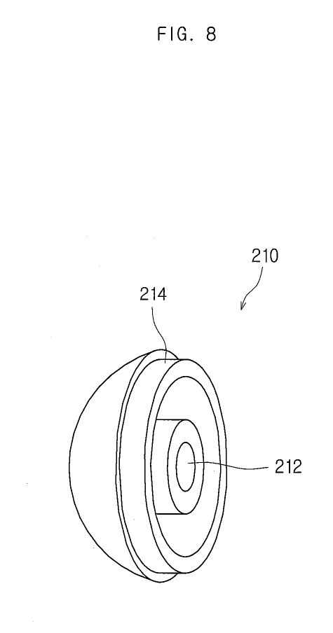

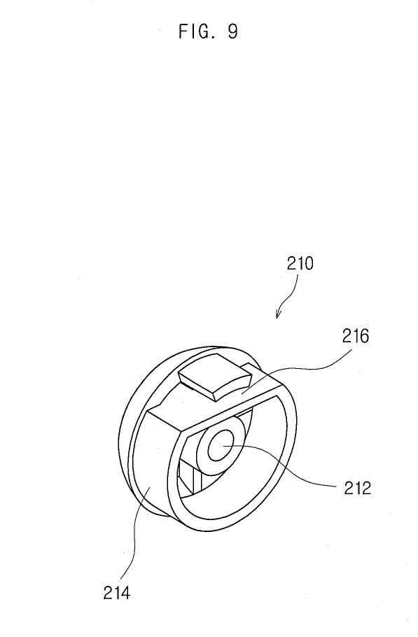

FIG. 8 is a perspective view of a rotation member 210 according to an embodiment of the present invention, and FIG. 9 is a perspective view of another type of rotation member 210 according to an embodiment of the present invention.

Referring to FIG. 2 and FIG. 8, a rotation member 210 according to the present embodiment may have a semi-spherical shape and may have a through-hole 212 formed in the center, as well as a raised portion 214 formed along the edge. As illustrated in FIG. 3, the first outer terminal 160 may be inserted in the through-hole 212, and the first rotational contact portion 162 of the first outer terminal 160 may be exposed through the through-hole 212 to the exterior. The first rotational contact portion 162 exposed to the exterior may be placed in contact with the first fixed contact portion 182 of the first inner terminal 180 secured to the lower housing 142. Also, the second rotational contact portion 172 of the second outer terminal 170 may be inserted and secured onto the raised portion 214. Since the rotation member 210 may be made from an insulating material, such as plastic, etc., the first inner terminal 180 and the second inner terminal 190 may not be electrically connected.

The rotation member 210 may be confined inside the upper housing 122 and lower housing 142 to be able to rotate 3-dimensionally. Thus, the rotation member 210 can rotate in any direction while confined by the housing 120, so that even when the external cable 270 (see FIG. 2) is moved in a certain direction, there may be no twisting or twirling in the cable. Also, even when the rotation member 210 is rotated, electrical contact may be maintained between the first outer terminal 160 and the first inner terminal 180, and between the second outer terminal 170 and the second inner terminal 190.

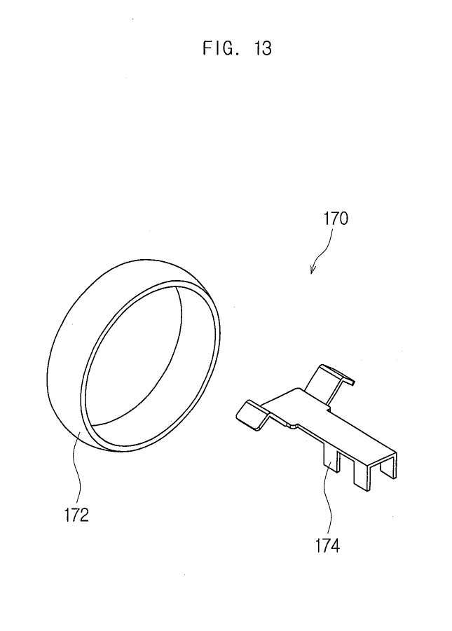

Referring to FIG. 9, a coupling indentation 216 can be formed in the raised portion 214 of the rotation member 210. Therefore, in cases where the second outer terminal 170 is formed by a second rotational contact portion 172 and a separate second outer connecting portion 174, as illustrated in FIG. 13, the second outer connecting portion 174 can be elastically deformed by the coupling indentation 216 and the second rotational contact portion 172 for coupling to the second rotational contact portion 172. This will be described further, with reference to FIG. 13, in the section on the second outer terminal 170.

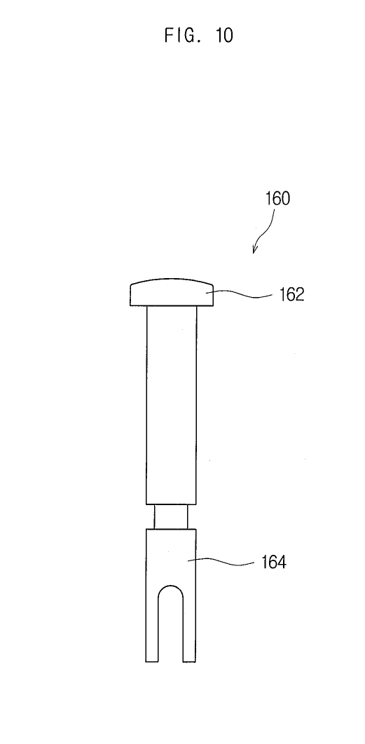

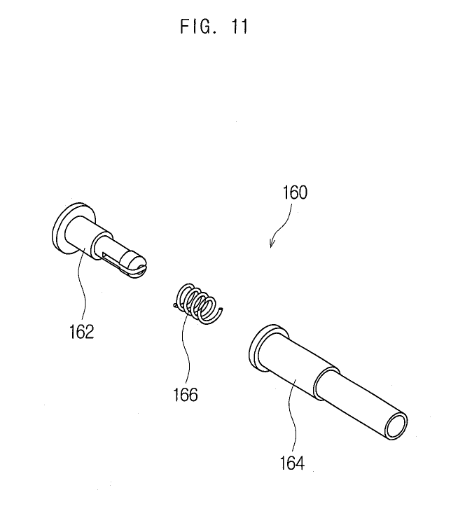

FIG. 10 is a front elevational view of a first outer terminal 160 in an electric connector apparatus 100 according to an embodiment of the present invention, and FIG. 11 is a perspective view of another type of first outer terminal 160 in an electric connector apparatus 100 according to an embodiment of the present invention.

Referring to FIG. 2 and FIG. 10, a first outer terminal 160 according to the present embodiment can be formed in the shape of a pin, with the first outer connecting portion 164 formed on one side and the first rotational contact portion 162 formed on the other side. The first outer terminal 160 may be inserted through the rotation member 210, as illustrated in FIG. 2, to rotate together with the rotation member 210 3-dimensionally. The first rotational contact portion 162 may be exposed to the exterior through the through-hole 212 of the rotation member 210, to be placed in contact with the first fixed contact portion 182 of the first inner terminal 180. The first outer connecting portion 164 may protrude in a direction opposite to the through-hole 212, to be connected with the cable 270 (see FIG. 2). Therefore, an electric current delivered through the cable may be transferred via the first outer connecting portion 164 and the first rotational contact portion 162 to the first fixed contact portion 182 of the first inner terminal 180.

Here, the first rotational contact portion 162 of the first outer terminal 160 may have a convex shape. Thus, the contact area between the first rotational contact portion 162 and the first fixed contact portion 182 of the first inner terminal 180 may be increased, so that the contact resistance may be reduced, and the transfer of electricity can be made more effective. Furthermore, the first fixed contact portion 182 of the first inner terminal 180 can have a concave shape, corresponding with the shape of the first outer terminal 160, to improve the transfer rate of electricity.

As illustrated in FIG. 11, the first outer terminal 160 can also be formed of a first outer connecting portion 164, and a separate first rotational contact portion 162 that may be coupled to the first outer connecting portion 164 in such a way that allows movement in a direction towards the first inner terminal 180. Here, a spring 166 may be interposed between the first outer connecting portion 164 and the first rotational contact portion 162, where this spring 166 may provide an elastic force to the first outer connecting portion 164 and the first rotational contact portion 162. In this way, the first rotational contact portion 162 may elastically press the first inner terminal 180, so that electrical contact may be maintained for the first inner terminal 180 and the first outer terminal 160. Also, the movability of the rotation member 210 may be improved, allowing the rotation member 210 to rotate 3-dimensionally with greater ease.

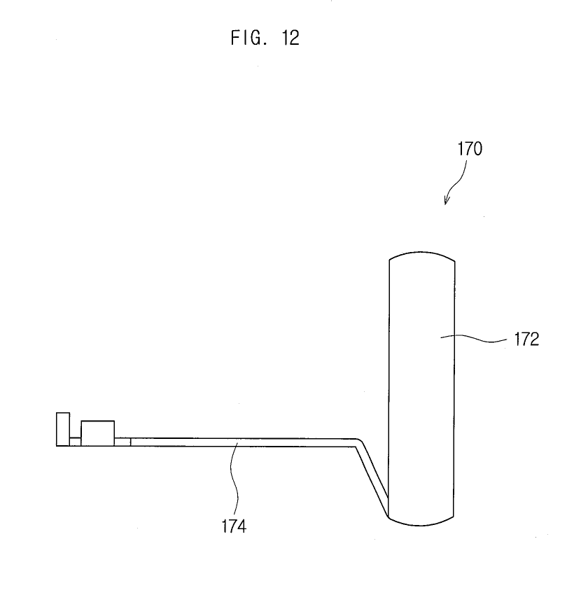

FIG. 12 is a side elevational view of a second outer terminal 170 in an electric connector apparatus 100 according to an embodiment of the present invention, and FIG. 13 is a perspective view of another type of second outer terminal 170 in an electric connector apparatus 100 according to an embodiment of the present invention.

Referring to FIG. 2 and FIG. 12, the second outer terminal 170 may be composed of a ring-shaped second rotational contact portion 172, which may be exposed at the surface of the rotation member 210 and surround the surface of the rotation member 210, and a second outer connecting portion 174, which may protrude from the second rotational contact portion 172. As a portion of the second outer terminal 170, i.e. the second rotational contact portion 172, may be shaped as a ring, the second inner terminal 190 and the second outer terminal 170 may maintain electrical contact more effectively when the rotation member 210 undergoes simple 2-dimensional rotation.

The second rotational contact portion 172, as illustrated in FIG. 3, may be inserted and secured onto the raised portion 214 of the rotation member 210. Thus, the second outer connecting portion 174 may protrude in the direction opposite to the through-hole 212. The second rotational contact portion 172 may elastically contact the second fixed contact portion 192 of the second inner terminal 190. The second outer connecting portion 174 may be connected with the cable 270 (see FIG. 2).

The second outer terminal 170 may rotate together with the rotation member 210 3-dimensionally. The second rotational contact portion 172 may have a certain width that makes it possible to maintain contact with the second inner terminal 190, even when the second outer terminal 170 is rotated.

Here, the second rotational contact portion 172 of the second outer terminal 170 may have a convex shape, while the second fixed contact portion 192 of the second inner terminal 190 may have a concave shape in correspondence with the shape of the second rotational contact portion 172. Thus, the contact area between the second rotational contact portion 172 and the second fixed contact portion 192 of the second inner terminal 190 may be increased, so that the contact resistance may be reduced, and the transfer of electricity can be made more effective.

The second outer terminal 170, as illustrated in FIG. 13, can be formed with the second rotational contact portion 172 and the second outer connecting portion 174 separate from each other. Thus, the rotation member 210, second outer terminal 170, and cap 230 can be assembled with greater ease.

Here, the second outer connecting portion 174 may, as illustrated in FIG. 9 and FIG. 13, be coupled to the second rotational contact portion 172 such that the second outer connecting portion 174 is elastically deformed by the coupling indentation 216 of the rotation member 210 and the second rotational contact portion 172. That is, the second outer connecting portion 174 may be held in the coupling indentation 216 such that one end of the second outer connecting portion 174 may be elastically deformed by the coupling indentation 216 and the second rotational contact portion 172 for coupling, when it is coupled to the second rotational contact portion 172. Thus, one end of the second outer connecting portion 174 may elastically press the second rotational contact portion 172, so that the second outer connecting portion 174 and the second rotational contact portion 172 may be coupled without a separate fastening means.

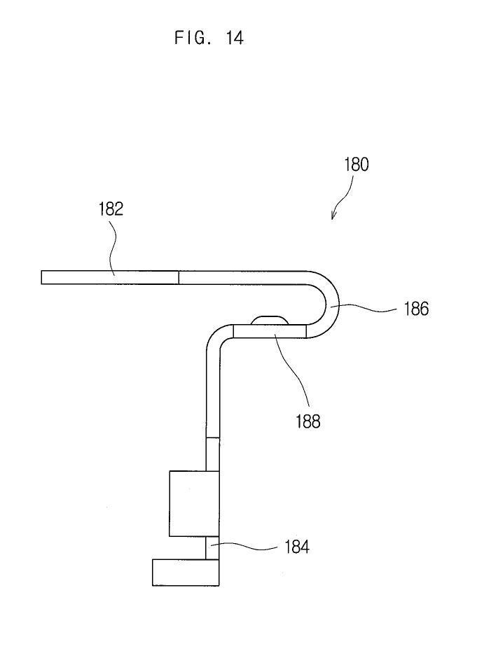

FIG. 14 illustrates a first inner terminal 180 in an electric connector apparatus 100 according to an embodiment of the present invention.

Referring to FIG. 2 and FIG. 14, a first inner terminal 180 according to the present embodiment may include a securing portion 188, which may be inserted onto the raised portion 150 of the lower housing 142, a first fixed contact portion 182, which may face the rotation member 210 when assembled, and a first inner connecting portion 184, which may face the exterior of the lower housing 142. The first fixed contact portion 182 may contact the first rotational contact portion 162 of the first outer terminal 160 inserted through the rotation member 210. Also, the first inner connecting portion 184 may be connected with an internal device of the electronic product (not shown). A curved portion 186 may be formed between the securing portion 188 and the first fixed contact portion 182. The curved portion 186 may provide a certain elastic force to the first fixed contact portion 182, allowing the first fixed contact portion 182 to elastically press the first rotational contact portion 162. In this way, electrical contact can be maintained between the first inner terminal 180 and the first outer terminal 160, while the movability of the rotation member can be improved, so that the rotation member 210 can readily undergo 3-dimensional rotations.

The first fixed contact portion 182 of the first inner terminal 180 may have a width corresponding to the possible range of movement of the first rotational contact portion 162 of the first outer terminal 160 that can be caused by the 3-dimensional rotating of the rotation member 210. That is, since the first rotational contact portion 162 of the first outer terminal 160 can be moved within a certain range by the rotation of the rotation member 210, the first fixed contact portion 182 of the first inner terminal 180 should have a width that can cover this range, in order to maintain electrical connection between the first inner terminal 180 and the first outer terminal 160 when the rotation member 210 undergoes 3-dimensional rotation. The width of the first outer terminal 160 may also be configured using the same principle as that for the first inner terminal 180, and the description on this matter will not be provided here in further detail.

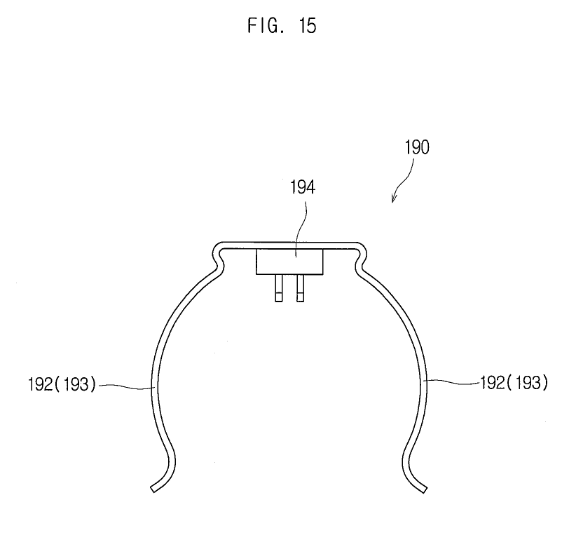

FIG. 15 is a front elevational view of a second inner terminal 190 in an electric connector apparatus 100 according to an embodiment of the present invention.

Referring to FIG. 2 and FIG. 15, a second inner terminal 190 according to the present embodiment may include a second fixed contact portion 192, which may be made from a pair of strips 193, and a second inner connecting portion 194, which may protrude from the second fixed contact portion 192. The second inner terminal 190 may be positioned inside the lower housing 142 and may elastically support the rotation member 210 when the upper housing 122 and lower housing 142 are coupled together. Therefore, the rotation member 210 may be capable of movement and of 3-dimensional rotations inside the housing 120.

Also, the pair of strips 193 may be placed in elastic contact with the outer perimeter of the second rotational contact portion 172 of the second outer terminal 170. Thus, electrical contact can be maintained between the second inner terminal 190 and the second outer terminal 170, while the movability of the rotation member can be improved, so that the rotation member 210 can readily undergo 3-dimensional rotations.

The strips 193 may be formed from a conductive material having elasticity, such as copper, etc., and may have a concave shape in correspondence with the shape of the rotation member 210. The strips 193 may have a certain width that allows electrical connection even when the second rotational contact portion 172 rotates 3-dimensionally. Also, the second inner connecting portion 194 may protrude through the second insertion hole 152 of the lower housing 142 to the exterior. The second inner connecting portion 194 may be connected with an internal device of the electronic product (not shown).

The second fixed contact portion 192 of the second inner terminal 190 may have a width corresponding to the possible range of movement of the second rotational contact portion 172 of the second outer terminal 170 that can be caused by the 3-dimensional rotating of the rotation member 210. That is, since the second rotational contact portion 172 of the second outer terminal 170 can be moved within a certain range by the rotation of the rotation member 210, the second fixed contact portion 192 of the second inner terminal 190 should have a width that can cover this range, in order to maintain electrical connection between the second inner terminal 190 and the second outer terminal 170 when the rotation member 210 undergoes 3-dimensional rotation. The width of the second outer terminal 170 may also be configured using the same principle as that for the second inner terminal 190, and the description on this matter will not be provided here in further detail.

A description will be provided as follows, with reference to FIG. 2 and FIG. 3, on coupling an electric connector apparatus 100 according to an embodiment of the present invention.

Referring to FIG. 2 and FIG. 3, the second inner terminal 190 may be positioned in the lower receiving indentation 144 of the lower housing 142. The second fixed contact portion 192 of the second inner terminal 190 may have a spherical shape, in correspondence with the shape of the lower housing 142. Also, the second inner connecting portion 194 of the second inner terminal 190 may protrude through the second insertion hole 152 of the lower housing 142 to the exterior.

The securing portion 188 of the first inner terminal 180 may be inserted and secured onto the raised portion 150 of the lower housing 142. Thus, the first fixed contact portion 182 of the first inner terminal 180 may be positioned inside the lower housing 142, while the first inner connecting portion 184 may be positioned outside the lower housing 142.

Since the first inner terminal 180 and the second inner terminal 190 may be positioned in the lower housing 142 with a certain gap spaced in-between, they may not be electrically connected to each other.

The first outer terminal 160 may be inserted in the through-hole 212 of the rotation member 210, whereby the first rotational contact portion 162 of the first outer terminal 160 may be exposed to the exterior of the rotation member 210. Also, the first outer connecting portion 164 of the first outer terminal 160 may protrude in a direction opposite to the through-hole 212. The second rotational contact portion 172 of the second outer terminal 170 may be inserted and secured onto the raised portion 214 of the rotation member 210. The rotation member 210 coupled with the second rotational contact portion 172 may be coupled with the cap 230 to be shaped as a sphere.

The rotation member 210 coupled with the first outer terminal 160 and the second outer terminal 170 may be inserted in the lower receiving indentation 144 of the lower housing 142. Here, the second inner terminal 190 may be secured to the lower housing 142, where the pair of strips 193 of the second inner terminal 190 may spread by a certain gap to hold the rotation member 210. Thus, the strips 193 of the second inner terminal 190 may contact the second rotational contact portion 172 of the second outer terminal 170. Also, when the rotation member 210 is inserted between the strips 193, the first rotational contact portion 162 may be placed in elastic contact with the first fixed contact portion 182.

An electric current delivered from an external power source through the cable 270 may be transferred through the first outer connecting portion 164 and the second outer connecting portion 174 to the first rotational contact portion 162 and the second rotational contact portion 172, respectively. The first rotational contact portion 162 can allow the electric current to flow through the first fixed contact portion 182 of the first inner terminal 180 to the first inner connecting portion 184, while the second rotational contact portion 172 can allow the electric current to flow through the second fixed contact portion 192 to the second inner connecting portion 194. The first inner connecting portion 184 and the second inner connecting portion 194 may each be connected with an internal device of the electronic product.

The first inner terminal 180 may be inserted and secured in the first insertion hole 148 of the lower housing 142, while the second inner terminal 190 may be inserted and secured in the lower receiving indentation 144. Then, the first outer terminal 160 may be inserted in the through-hole 212 of the rotation member 210, and the second outer terminal 170 may be coupled to the raised portion 214, after which the rotation member 210 and the cap 230 can be coupled together, to be inserted in the lower receiving indentation 144 of the lower housing 142 such that parts of the first outer connecting portion 164 and the second outer connecting portion 174 are positioned in the receiving hole 232 of the cap 230. Here, the first rotational contact portion 162 of the first outer terminal 160 may contact the first fixed contact portion 182 of the first inner terminal 180, while the second rotational contact portion 172 of the second outer terminal 170 may contact the second fixed contact portion 192 of the second inner terminal 190. Then, the securing protrusions 136 formed on the upper housing 122 may be inserted into the coupling holes 156 formed in the lower housing 142 to complete the housing 120. After the housing 120 is completed, it may be secured to the casing of the electronic product using screws (not shown), etc.

The rotation member 210 positioned inside the housing 120 may be guided by the inner perimeters of the upper housing 122 and lower housing 142, to be capable of rotating 3-dimensionally. Here, the first outer terminal 160 and second outer terminal 170 coupled with the rotation member 210 may rotate together. Since the first outer terminal 160 and the second outer terminal 170 may contact the first inner terminal 180 and the second inner terminal 190, even with the rotating of the rotation member 210, the electric current supplied from the external power source can be supplied continuously to the internal device.

Such an electric connector apparatus can be applied to small, hand-held electronic products, such as curling irons, hair dryers, and electric razors, etc.

While the spirit of the invention has been described in detail with reference to particular embodiments, it is to be appreciated that those skilled in the art can change or modify the embodiments without departing from the scope and spirit of the invention.

### INDUSTRIAL APPLICABILITY

According to embodiments of the present invention, an electric connector apparatus may be provided that can rotate 3-dimensionally in accordance with the movement of the cable while maintaining electrical connection.

Also, an electric connector apparatus may be provided that can prevent defective links or disconnections and increase durability.

1. An electric connector apparatus comprising:
a housing secured to an electronic product;
a first inner terminal and a second inner terminal secured to the housing and electrically connected to an internal device of the electronic product;
a rotation member coupled to the housing such that the rotation member is 3-dimensionally rotatable; and
a first outer terminal and a second outer terminal secured to the rotation member and electrically connected to an external power source, the first outer terminal and the second outer terminal maintaining contact with the first inner terminal and the second inner terminal, respectively.

2. The electric connector apparatus according to claim 1, wherein the first outer terminal and the second outer terminal are partially exposed at a surface of the rotation member and are spaced apart from each other such that the first outer terminal and the second outer terminal are electrically separated.

3. The electric connector apparatus according to claim 2, wherein a portion of the second outer terminal exposed at the surface of the rotation member is shaped as a ring surrounding the surface of the rotation member.

4. The electric connector apparatus according to claim 1, wherein at least one pair of the first inner terminal and the first outer terminal, and the second inner terminal and the second outer terminal, are in elastic contact with each other.

5. The electric connector apparatus according to claim 4, wherein the first outer terminal comprises:
a first outer connecting portion secured to the rotation member and electrically connected with the external power source;
a first rotational contact portion coupled to the first outer connecting portion such that the first rotational contact portion is movable towards the first inner terminal; and
a spring interposed between the first outer connecting portion and the first rotational contact portion such that the first inner terminal and the first rotational contact portion maintain contact with each other.

6. The electric connector apparatus according to claim 1, wherein the second inner terminal elastically supports the rotation member.

7. The electric connector apparatus according to claim 1, wherein the first outer terminal and the second outer terminal have convex shapes, and
at least one of the first inner terminal and the second inner terminal has a concave shape corresponding with the shapes of the first outer terminal and the second outer terminal.

8. The electric connector apparatus according to claim 1, wherein the second outer terminal comprises:
a second rotational contact portion positioned in contact with the second inner terminal; and
a second outer connecting portion electrically connected with the external power source and formed independently of the second rotational contact portion, the second outer connecting portion coupled to the second rotational contact portion.

9. The electric connector apparatus according to claim 8, wherein the second outer connecting portion is elastically deformed when coupled to the second rotational contact portion.

10. The electric connector apparatus according to claim 1, wherein the rotation member is shaped as at least a portion of a sphere, and
a receiving indentation is defined inside the housing in correspondence with the rotation member such that the receiving indentation holds the rotation member.

11. The electric connector apparatus according to claim 10, wherein the receiving indentation defines an opening, the opening of the receiving indentation exposing the first outer terminal and the second outer terminal and having a smaller width than a maximum diameter of the rotation member.

12. The electric connector apparatus according to claim 11, wherein the opening is circular.

13. The electric connector apparatus according to claim 1, further comprising:
a cap secured to an end portion of the rotation member, the cap configured to prevent foreign substances from entering the housing.
